(19) United States
(12) Patent Application Publication
(10) Pub. No.: US 2022/0346596 A1
(43) Pub. Date: Nov. 3, 2022

(54) COOKING APPLIANCE

(71) Applicant: BSH Hausgeräte GmbH, Munich (DE)

(72) Inventors: Dan Neumayer, Bernau (DE); Luis Sanroman Hernandez, Zaragoza (ES); Carlos Obon Abadia, Santa Isabel (Zaragoza) (ES)

(21) Appl. No.: 17/625,787

(22) PCT Filed: Jul. 7, 2020
(86) PCT No.: PCT/EP2020/069073

§ 371 Date: Jan. 10, 2022

(30) Foreign Application Priority Data
Jul. 15, 2019 (DE) 10 2019 210 395.2

(51) Int. Cl. A47J 37/06; F24C 15/20; F24C 15/32; H05B 6/12

(52) U.S. Cl. CPC A47J 37/0641; F24C 15/2007; F24C 15/2042; F24C 15/322; H05B 6/129

(57) ABSTRACT

A cooking appliance apparatus includes a fan unit, a sensor unit designed to detect an electrical fan parameter of the fan unit, a filter unit allocated to the fan unit, and a control unit designed to determine a filter parameter of the filter unit in dependence upon the fan parameter.

The invention relates to a cooking appliance apparatus according to the preamble of claim 1 and a method for operation of a cooking appliance apparatus according to the preamble of claim 12.

A cooking appliance apparatus that has a fan unit and is embodied as an oven apparatus is already known from the prior art. The fan unit has a fan wheel and at least one drive motor that drives the fan wheel in an operating state. A sensor unit of the cooking appliance apparatus in the operating state detects an electric fan parameter of the fan unit. A control unit of the cooking appliance apparatus in the operating state evaluates the fan parameter and monitors a function of the drive motor in dependence upon the fan parameter.

The object of the invention resides in particular in providing an apparatus of the generic type having improved characteristics with regard to an operator comfort. The object is achieved in accordance with the invention by the features of claims 1 and 12 while advantageous embodiments and developments of the invention are apparent in the subclaims.

The invention is based on a cooking appliance apparatus, in particular on an induction cooking appliance apparatus, advantageously on an oven apparatus and particularly advantageously on an induction oven apparatus having at least one fan unit that has in particular at least one fan wheel and in particular at least one drive motor for driving the fan wheel, and having at least one sensor unit that is provided so as to detect at least one electric and/or electronic fan parameter of the fan unit, in particular of the drive motor.

It is proposed that the cooking appliance apparatus has at least one control unit that is provided so as to determine, in dependence upon the fan parameter, at least one filter parameter of at least one filter unit, which is allocated to the fan unit.

It is possible by an embodiment of this type in particular to achieve a high degree of operator comfort. It is possible to omit a separate and/or additional sensor unit that is provided so as to detect the filter parameter whereby in particular it is possible to achieve a cost-effective embodiment and/or low inventory levels. In particular, it is possible owing to the knowledge of the filter parameter to render possible a correct operation and/or to avoid damage to the filter unit. It is possible to relieve an operator of having to manually ensure a correct operation whereby in particular it is possible to achieve a high degree of operator comfort.

The term a “cooking appliance apparatus”, in particular the term an “induction cooking appliance apparatus”, advantageously the term an “oven apparatus” and particularly advantageously the term an “induction oven apparatus” is to be understood in particular to mean at least a part, in particular a subassembly, of a cooking appliance, in particular of an induction cooking appliance, advantageously of an oven and particularly advantageously of an induction oven. For example, the cooking appliance could have at least one hob, in particular at least one induction hob, and can be embodied in particular as a hob, in particular as an induction hob. The cooking appliance could be embodied for example as a grill and/or as a microwave. It is preferred that the cooking appliance has at least one oven, in particular at least one baking oven and/or at least one stove, and is in particular embodied as an oven.

In particular, the cooking appliance apparatus has at least one muffle that in particular at least in part defines and/or delimits at least one cooking compartment. The cooking appliance apparatus in particular has at least one appliance door that in particular at least in part defines and/or delimits the cooking compartment. The expression that an object “at least in part” defines and/or delimits a cooking compartment is in particular to be understood to mean that the object defines and/or delimits the cooking compartment alone or together with at least one further object. In particular, the muffle and the appliance door together in an operating state define and/or delimit the cooking compartment, in particular at least to a large extent, advantageously at least essentially and particularly advantageously entirely. The expression “at least to a large extent” is in particular to be understood to mean a proportion, in particular a mass portion and/or a volume portion and/or a portion of a number, of at least 70%, in particular of at least 80%, advantageously of at least 90% and preferably of at least 95%.

The term a “fan unit” is to be understood in particular to mean a unit that, in particular by means of the fan wheel, provides at least one in particular oriented air flow, in particular at least of a gaseous dispersion medium. The fan unit blows, in particular by means of the fan wheel, in particular the air flow in at least one specific direction. In particular, the fan unit draws in at least one gaseous dispersion medium, in particular air, by means of an intake pressure and provides the gaseous dispersion medium that is drawn in by means of a discharging pressure. In particular, the drive unit in an operating state drives the fan wheel. The drive unit has in particular at least one electric motor and is in particular embodied as an electric motor.

The term a “sensor unit” is to be understood in particular to mean a unit that has at least one detector for detecting at least one sensor parameter and that is in particular provided so as to output a value that characterizes the sensor parameter, wherein the sensor parameter is advantageously a physical and/or chemical variable. For example, the sensor unit could actively detect the sensor parameter in an operating state such as in particular by generating and emitting a measuring signal, in particular an electric and/or optical measuring signal. Alternatively or in addition thereto, the sensor unit could detect the sensor parameter in an operating state in an in particular passive manner such as in particular by a detection of at least one characteristic change of at least one sensor component and/or the detector. The sensor parameter has in particular at least the fan parameter and is in particular embodied as the fan parameter.

The fan parameter could comprise for example at least one electrical current that could guide the fan unit, in particular the drive motor, in particular in an operating state and/or that in particular could be provided for operation of the drive motor. In particular alternatively or in addition thereto, the fan parameter could comprise at least one electrical voltage that could prevail in an operating state in particular at the fan unit, in particular at the drive motor, and/or that in particular could be provided for operation of the drive motor. For example, the fan parameter, in particular alternatively or in addition thereto, could comprise at least one electrical power that could be provided in particular for a drive of the fan unit, in particular of the drive motor, and/or that could be provided in particular for operation of the drive motor. In particular alternatively or in addition thereto, the fan parameter could comprise at least one rotational speed, in particular of the drive motor and/or the fan wheel. The sensor unit could detect for example, in particular alternatively or in addition thereto, at least one temperature, in particular of the fan unit and/or advantageously of the drive motor.

The term a “control unit” is to be understood in particular to mean an electronic unit that controls and/or regulates in an operating state at least one cooking appliance function and/or at least one cooking appliance main function, in particular a heating of the muffle. The control unit in particular has at least one computing unit and in particular in addition to the computing unit at least one storage unit in which in particular at least one control and/or regulating program is stored that in particular is provided for execution by the computing unit. In particular, the control unit is provided so as to control and/or regulate at least one in particular electrical and/or electronic cooking appliance object that is different to the control unit. The term a “cooking appliance object” is to be understood in particular to mean at least a part, in particular a subassembly of a cooking appliance, in particular of an induction cooking appliance. At least one cooking appliance object could be for example at least one operator interface and/or at least one heating unit and/or at least one inverter and/or at least the fan unit and/or at least one cooking appliance electronic system.

The cooking appliance apparatus has in particular at least one filter unit and advantageously at least the filter unit. The expression that the filter unit is “allocated” to the fan unit is to be understood in particular to mean that the filter unit is provided for a filtering at least of an air flow that is caused by the fan unit. The air flow could be for example an intake flow and/or a discharge flow. In an assembled state of the filter unit, the filter unit is arranged in particular in a vicinity of the fan unit, in particular of the fan wheel.

The filter unit is advantageously provided for a filtering at least of an intake flow that is caused by the fan unit and said intake flow is in particular drawn out from the cooking compartment by the fan unit. The term a “filter unit” is to be understood in particular to mean a unit that is provided so as in an operating state to filter dissolved particles in at least one air flow that is provided in particular by the fan unit and at least in part to remove said dissolved particles in particular from the air flow. The particles could be for example grease particles.

The term “provided” is in particular to be understood to mean specifically programmed, designed and/or equipped. The fact that an object is provided for a specific function, is in particular to be understood to mean that the object fulfils and/or performs this specific function in at least one application state and/or operating state.

Moreover, it is proposed that the control unit maintains at least one further fan parameter, in particular each further fan parameter, as at least essentially and advantageously entirely constant for the determination of the filter parameter. The further fan parameter could comprise for example at least one electrical current and/or at least one electrical voltage and/or at least one electrical power and/or at least one rotational speed. In particular in the case in which the fan parameter comprises at least one electrical current, the control unit could maintain at least one further fan parameter as essentially constant for the determination of the filter parameter and said further fan parameter comprises at least one electrical voltage and/or at least one rotational speed. The expression that the control unit maintains at least one further fan parameter as “at least essentially constant” for the determination of the filter parameter is understood in particular to mean that for the determination of the filter parameter the control unit maintains a value of the further fan parameter in a range that is delimited and/or defined by a minimum value and a maximum value and at which a quotient of the minimum value and the maximum value assumes a value of at least 0.8, in particular of at least 0.85, advantageously of at least 0.9, particularly advantageously of at least 0.92, preferably of at least 0.95 and particularly preferably of at least 0.98. As a consequence, it is possible in particular to render it possible to optimally evaluate the filter parameter since in particular it is possible to minimize further influence factors.

The control unit could take into consideration at least one reference fan parameter in the case of determining the filter parameter. In particular, the control unit could relate the reference fan parameter of at least one further unit. The further unit could have for example an operator interface and/or could be embodied as an operator interface. Advantageously, the further unit could have at least one external unit and/or could be embodied as an external unit. The external unit could be for example a mobile device and/or a network, such as for example the internet. It is preferred that the control unit has at least one storage unit and at least one reference fan parameter is stored in said storage unit and the control unit takes said reference fan parameter into consideration in the case of determining the filter parameter. The reference fan parameter is in particular embodied as a reference parameter that is allocated to the fan parameter. In particular, the control unit compares the fan parameter with the reference fan parameter for the determination of the filter parameter. For example, at least two, in particular at least three, advantageously at least four, particularly advantageously at least six, preferably at least eight and particularly preferably a plurality of reference fan parameters are stored in the storage unit. As a consequence, the filter parameter can be determined in particular in a particularly exact manner whereby in particular a high degree of operator comfort can be provided.

Furthermore, it is proposed that the cooking appliance apparatus has in particular at least the filter unit and at least one air guiding unit that is provided in particular so as to guide at least one airflow that is provided by the fan unit, and it is possible to arrange the filter unit in a reversible manner on said air guiding unit. In particular, the filter unit can be arranged on the air guiding unit in a manner in which said filter unit can be detached, in particular in a non-destructive manner, without tools and/or said filter unit can be separated from the air guiding unit. For example, in an assembled state of the filter unit the filter unit could be arranged on the air guiding unit by means of at least one screw connection and/or by means of at least one latch connection and/or by means of at least one connection that is provided by clamping and/or by means of at least one connection that is provided by interlocking. As a consequence, it is possible in particular to achieve a high degree of flexibility. In particular, in selected cooking processes in which in particular a presence of the filter unit is advantageous, the filter unit can be arranged on the air guiding unit and in further cooking processes, in which in particular it is possible to omit a presence of the filter unit, the filter unit can be omitted. As a consequence, in particular it is possible to obtain an embodiment with a long serviceable life, in particular of the filter unit. In particular, the selected cooking process could comprise at least one cooking process that is referred to as “pyrolysis” and/or at least one cooking process that is referred to as “barbecue”. In particular, the further cooking process could comprise at least one cooking process that is referred to as “hot air”.

Moreover, it is proposed that the filter unit has at least one smoke filter and in particular is embodied as a smoke filter. In particular, the filter unit has at least one filter element having an in particular defined pore size that determines in particular a particle size that can be filtered by the filter unit. It is possible by selecting and/or setting the pore size in particular to set a pressure in the cooking compartment. In particular, the pore size is selected as sufficiently large in order to render it possible to intake and/or to ensure an intake of smoke through the fan unit from the cooking compartment. The pore size is in particular selected as small as possible in order in particular to render possible and/or to ensure a filtering of particles of a specific size that are in the air flow. As a consequence, it is possible in particular to filter smoke that is drawn out of the cooking compartment whereby in particular a soiling of the fan unit is achieved and/or a low cleaning frequency can be rendered possible for an operator. It is in particular possible to achieve an embodiment with a long serviceable life.

Moreover, it is proposed that the cooking appliance apparatus has at least one muffle that at least in part delimits at least one cooking compartment and the filter unit is arranged within said cooking compartment in at least one assembled state of the filter unit. In particular, the filter unit in the assembled state of the filter unit is arranged on a side of the fan unit that is facing the cooking compartment. As a consequence, a simple accessibility of the filter unit can be rendered possible whereby an operator can assemble and disassemble the filter unit in particular in a simple manner. As a consequence, it is possible in particular to provide a particularly high degree of operator comfort.

The fan parameter could comprise for example at least one electrical voltage and/or at least one electrical power and/or at least one rotational speed. It is preferred that the fan parameter comprises at least one electrical current that is provided in particular for operation of the drive motor. The sensor unit could comprise for example at least one ammeter that could be provided in particular so as to detect the fan parameter. As a consequence, it is possible to detect the fan parameter in a particularly simple manner whereby in particular it is possible to achieve an uncomplicated and/or cost-effective embodiment.

Moreover, it is proposed that the filter parameter comprises at least one presence parameter and in particular denotes and/or characterizes a presence and/or an absence of the filter unit on the fan unit. In particular, the control unit determines, in dependence upon the filter parameter, at least a presence and/or at least an absence of the filter unit on the fan unit. The control unit could be provided, for example in the case of a cooking process in which a presence of the filter unit is advantageous, so as to output at least one item of information in dependence upon the filter parameter and by means of said item of information the control unit could request that an operator in particular attach the filter unit and/or the control unit could confirm to an operator that the filter unit is present on the fan unit. The control unit could be provided, for example, in the case of a cooking process in which in particular it is possible to omit the filter unit, so as to output at least one item of information in dependence upon the filter parameter and by means of said item of information the control unit could request that an operator detach the filter unit and/or by means of said item of information the control unit could confirm to an operator that the filter unit is not present on the fan unit. As a consequence, it is possible in particular to achieve a particularly high degree of operator comfort. In particular, it is possible for an operator to be informed in a simple manner regarding a presence and/or an absence of the filter unit whereby in particular it is possible to relieve the operator of having to perform complex procedure of inspection.

Moreover, it is proposed that the filter parameter comprises at least one soiling parameter and in particular a soiling and/or a degree of soiling of the filter unit is denoted and/or characterized. The control unit determines at least one degree of soiling of the filter unit, in particular in dependence upon the filter parameter. The cooking appliance apparatus has in particular at least one pressure sensor unit that is provided in particular so as to detect at least one pressure parameter. The pressure parameter defines and/or characterizes in particular at least one pressure that decreases at the filter unit. The control unit in particular at the start of at least one cooking process, in particular under specific and/or prevailing boundary conditions, stores in the storage unit at least one pressure parameter that is detected in particular by means of the pressure sensor unit. In particular, the control unit repeats a detection of the pressure parameter in particular by means of the pressure sensor unit at a later point in time, for example during the cooking process and/or at the end of the cooking process. The control unit determines the soiling parameter and/or the degree of soiling of the filter unit, in particular from a comparison of the pressure parameter at a start of the cooking process and the pressure parameter at a later point in time. In particular, the control unit determines the soiling parameter, in particular exclusively, in the case of cooking processes in which the filter unit is arranged on the air guiding unit. For example, the control unit could be provided so as, in dependence upon the soiling parameter, to output at least one item of information and by means of said item of information the control unit could request that an operator in particular cleans the filter unit. The control unit could for example permit and/or block a cooking process in dependence upon the soiling parameter. In particular, the control unit could block the cooking process in the event of too high a degree of soiling and in particular could request that an operator clean the filter unit. As a consequence, it is possible in particular to identify a soiling of the filter unit in a simple manner whereby in particular it is possible to avoid a cooking process with a soiled filter unit. In particular, an efficient cooking process can be rendered possible since in particular an intake through a soiled filter unit can be avoided and thereby a cooking process that saves energy can be rendered possible.

In the case of determining the filter parameter, in particular in addition to the fan parameter, the control unit could take into consideration for example at least one further fan parameter. It is preferred that the cooking appliance apparatus has at least one appliance door and the control unit takes into consideration the opening state of said appliance door, in particular with regard to a saturation of the fan parameter, in the case of determining the filter parameter. In particular, at least one reference fan parameter, which is allocated to an opened state of the appliance door, and at least one reference fan parameter, which is allocated to a closed state of the appliance door is stored in the storage unit of the control unit. In particular, the fan parameter has different saturations in dependence upon the opening state of the appliance door. A saturation of the fan parameter depends in particular on the opening state of the appliance door. As a consequence, in particular it is possible to achieve a particularly precise determination of the filter parameter whereby in particular it is possible to provide a high degree of operator comfort.

A particularly high degree of operator comfort can be achieved in particular by a cooking appliance, in particular by an induction cooking appliance, advantageously by an oven and particularly advantageously by an induction oven having at least one cooking appliance apparatus in accordance with the invention.

An operator comfort can be in particular further increased by a method for operation of a cooking appliance apparatus in accordance with the invention and said cooking appliance apparatus has in particular at least one fan wheel and in particular at least one drive motor for a drive of the fan wheel, and having at least one sensor unit that is provided for a detection of at least one electrical and/or electronic fan parameter of the fan unit, in particular of the drive motor, wherein at least one filter parameter of at least one filter unit, which is allocated to the fan unit, is determined in dependence upon the fan parameter.

The cooking appliance apparatus in this case is not to be limited to the above-described application and embodiment. In particular, the cooking appliance apparatus can have a number of individual elements, components and units that deviates from the number mentioned herein so as to fulfil a function described herein.

Further advantages are provided in the following description of the drawing. Exemplary embodiments of the invention are illustrated in the drawing. The drawing, the description and the claims contain numerous features in combination. The person skilled in the art will also expediently take the features into consideration individually and will combine said features to useful further combinations.

In the drawings:

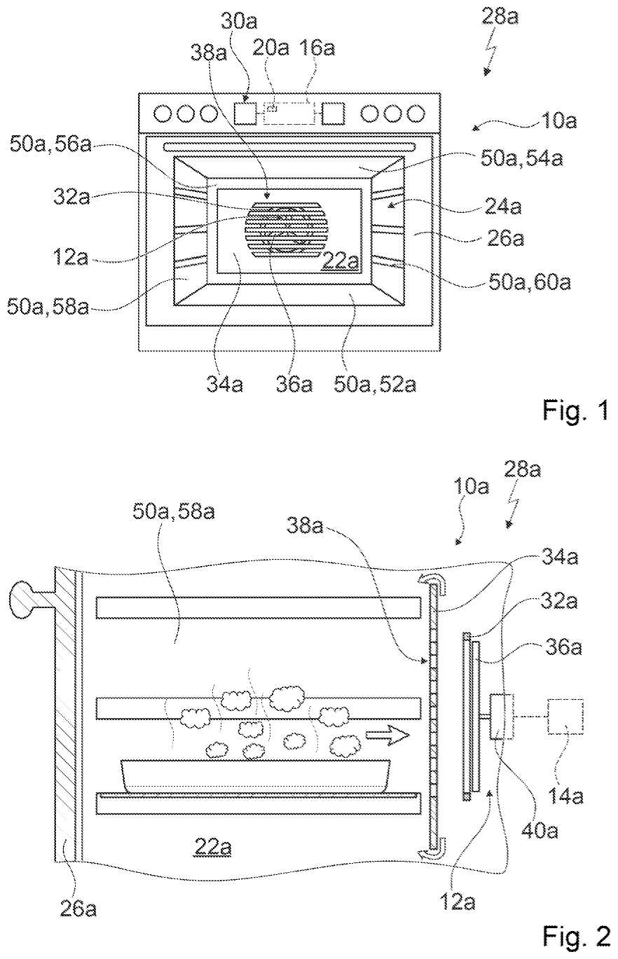

FIG. 1 shows a cooking appliance having a cooking appliance apparatus in a schematic view,

FIG. 2 shows the cooking appliance having the cooking appliance apparatus in a disassembled state of a filter unit of the cooking appliance apparatus in a schematic sectional view,

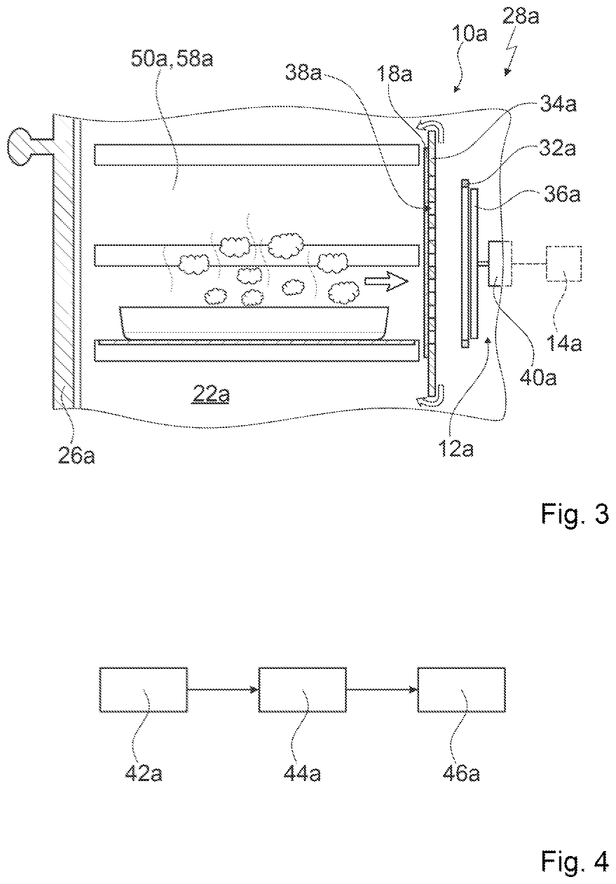

FIG. 3 shows the cooking appliance having the cooking appliance apparatus in an assembled state of a filter unit of the cooking appliance apparatus in a schematic sectional view and

FIG. 4 shows a diagram of a method for operation of the cooking appliance apparatus in a schematic view.

FIG. 1 illustrates in particular a cooking appliance 28a that is embodied in particular as an induction cooking appliance. The cooking appliance 28a could be embodied for example as a hob, in particular as an induction hob. In particular alternatively or in addition thereto, the cooking appliance 28a could be embodied for example as a grill appliance. In the present exemplary embodiment, the cooking appliance 28a is embodied in particular as an oven, advantageously as an induction oven.

The cooking appliance 28a has in particular at least one and advantageously precisely one cooking appliance apparatus 10a that is embodied in particular as an induction cooking appliance apparatus. For example, the cooking appliance apparatus 10a could be embodied as a hob apparatus, in particular as an induction hob apparatus. The cooking appliance apparatus 10a in the present exemplary embodiment is embodied in particular as an oven apparatus, in particular as an induction oven apparatus.

The cooking appliance apparatus 10a has in particular at least one and advantageously precisely one muffle 24a. The muffle 24a at least in part delimits in particular at least one and advantageously precisely one cooking compartment 22a. The muffle 24a at least essentially delimits the cooking compartment 22a in particular together with an appliance door 26a. The cooking appliance apparatus 10a has in particular at least one and advantageously at least the appliance door 26a.

The appliance apparatus 10a in the present exemplary embodiment has in particular five cooking compartment walls 50a. The cooking compartment walls 50a are in particular part of the muffle 24a. In particular, the muffle 24a has the cooking compartment walls 50a. In particular together with the appliance door 26a, the cooking compartment walls 50a at least essentially define the cooking compartment 22a.

One of the cooking compartment walls 50a is in particular embodied as a base wall 52a. One of the cooking compartment walls 50a is in particular embodied as a cover wall 54a. One of the cooking compartment walls 50 is in particular embodied as a rear wall 56a. Two of the cooking compartment walls 50a are in particular in each case embodied as a side wall 58a, 60a. In particular, only one of the cooking compartment walls 50a is described below.

The cooking appliance apparatus 10a has in particular at least one and advantageously precisely one operator interface 30a, in particular for an input and/or selection of operating parameters, for example of a heating power and/or of a heating power density and/or a heating zone. The operator interface 30a is in particular provided so as to output a value of an operating parameter to an operator.

The cooking appliance apparatus 10a has in particular at least one and advantageously precisely one control unit 16a. The control unit 16a is in particular provided so as to perform actions and/or to change settings in dependence upon operating parameters that are input by means of the operator interface 30a. The control unit 16a regulates, in particular in a heating operating state, a supply of energy to at least one heating element 32a.

In the present exemplary embodiment, the cooking appliance apparatus 10a in particular has at least one and advantageously precisely one, in particular at least the, and advantageously precisely the, heating element 32a. The heating element 32a is in particular embodied as a ring heating element. In particular, the heating element 32a is embodied as a resistance heating element.

The heating element 32a is in particular arranged in a rearward region of the muffle 24a. In particular, the heating element 32a is arranged within the cooking compartment 22a.

In particular in addition to the heating element 32a, the cooking appliance apparatus 10a could have for example at least one second heating element and advantageously at least one third heating element (not illustrated). The second heating element and/or the third heating element could be embodied in particular as an inductor.

In particular, the second heating element could be arranged outside of the cooking compartment 22a. The second heating element could be arranged in an installation position in particular above the cover wall 54a and in particular in a vicinity of the cover wall 54a. In particular, the second heating element could be provided so as to provide top heat. In one operating state in which the control unit 16a operates the second heating element, the second heating element in particular provides a top heat.

In particular, the third heating element could be arranged outside of the cooking compartment 22a. The third heating element could be arranged in an installation position in particular below the base wall 52a and in particular in a vicinity of the base wall 52a. In particular, the third heating element could be provided so as to provide bottom heat. In one operating state in which the control unit 16a operates the third heating element, the third heating element in particular provides a bottom heat.

The cooking appliance apparatus 10a in particular has at least one and advantageously precisely one fan unit 12a. In particular, the fan unit 12a has at least one fan wheel 36a. The fan unit 12a, in particular by means of the fan wheel 36a, is provided in particular so as to provide at least one airflow.

The fan unit 12a has in particular at least one and advantageously precisely one drive motor 40a (cf. FIGS. 2 and 3) for a drive of the fan wheel 36a. In particular, the drive motor 40a is embodied as an electric motor. In an operating state, the drive motor 40a drives the fan wheel 36a in particular by means of a drive torque.

The cooking appliance apparatus 10a has in particular at least one and advantageously precisely one air guiding unit 34a (cf. FIGS. 1 to 3). The air guiding unit 34a is arranged in particular within the cooking compartment 22a. In an assembled state, a main extent plane of the air guiding unit 34a is oriented in particular at least essentially parallel with respect to a main extent plane of the rear wall 56a.

The term a “main extent plane” of an object is in particular to be understood to mean a plane that is parallel with respect to a largest side surface of a smallest conceived geometric cuboid that only just completely encompasses the object and in particular extends through the center point of the cuboid. The term “essentially parallel” is to be understood here to mean in particular an orientation of a direction relative to a reference direction, in particular in a plane, wherein the direction with respect to the reference direction has a deviation in particular of maximum 8°, advantageously maximum 5° and particularly advantageously maximum 2°.

In an assembled state, the fan unit 12a, in particular the fan wheel 36a and/or the drive motor 40a, is arranged on a side of the air guiding unit 34a that is facing the rear wall 56a. The air guiding unit 34a is in particular provided so as to guide an air flow that is provided by the fan unit 12a. In an operating state, the air guiding unit 34a guides in particular an airflow that is provided by the fan unit 12a.

The air guiding unit 34a has in particular at least one passage region 38a that is provided in particular for a passage of at least one air flow. In particular, the fan unit 12a, in particular by means of the fan wheel 36a, in an operating state draws in air through the passage region 38a from a cooking region of the cooking compartment 22a.

The cooking appliance apparatus 10a has in particular at least one and advantageously precisely one filter unit 18a (cf. FIG. 3). The filter unit 18a is in particular provided so as in an operating state to filter at least an air flow that is provided by the fan unit 12a and in particular to at least in part remove from the airflow particles that are in the airflow.

The filter unit 18a has in particular at least one and advantageously precisely one smoke filter. In particular, the filter unit 18a by means of the smoke filter in an operating state filters at least one airflow that is provided by the fan unit 12a and at least in part removes from the airflow in particular particles that are in the airflow. The filter unit 18a is in particular allocated to the fan unit 12a.

The filter unit 18a can be arranged, in particular in a reversible manner, on the air guiding unit 34a. The filter unit 18a in an assembled state of the filter unit 18a is arranged on the air guiding unit 34a in a detachable manner in particular without tools. For example, the filter unit 18a could be arranged on the air guiding unit 34a in an assembled state of the filter unit 18a by means of a latch connection.

In an assembled state of the filter unit 18a, the filter unit 18a is in particular arranged within the cooking compartment 22a. In particular, the filter unit 18a in an assembled state of the filter unit 18a is arranged on a side of the air guiding unit 34a that is remote from the rear wall 56a.

The filter unit 18a is arranged in an assembled state of the filter unit 18a in particular when viewed in the fluid flow direction of an intake flow upstream of the passage region 38a. In particular, the passage region 38a and the filter unit 18a in an assembled state of the filter unit 18a are arranged in an in particular overlapping manner in the case of a perpendicular view of a main extent plane of the air guiding unit 34a. In the case of a perpendicular view of a main extent plane of the air guiding unit 34a, the passage region 38a is arranged in particular within a surface that is spanned by the filter unit 18a.

The cooking appliance apparatus 10a has in particular at least one and advantageously precisely one sensor unit 14a (cf. FIGS. 2 and 3). In the FIGS. 2 and 3, the sensor unit 14a is in particular only illustrated schematically. The sensor unit 14a is provided in particular so as to detect at least one electric fan parameter of the fan unit 12a. In an operating state, the sensor unit 14a detects in particular the electric fan parameter of the fan unit 12a.

In an operating state, the sensor unit 14a detects in particular an electric fan parameter of the drive motor 40a of the fan unit 12a. In the present exemplary embodiment, the fan parameter comprises at least one electrical current that is provided in particular for operation of the drive motor 40a.

In an operating state, the control unit 16a determines in particular, in dependence upon the fan parameter, at least one filter parameter of the filter unit 18a, which is allocated to the fan unit 12a. In particular, the control unit 16a is provided so as to determine, in dependence upon the fan parameter, the filter parameter of the filter unit 18a, which is allocated to the fan unit 12a.

The control unit 16a maintains at least a further fan parameter as at least essentially constant so as to determine the filter parameter (cf. also the table below). In the present exemplary embodiment, the further fan parameter comprises in particular at least one electrical voltage that is provided in particular for operation of the drive motor 40a. In particular, the further fan parameter comprises at least one rotational speed.

The control unit 16a has in particular at least one storage unit 20a (cf. FIG. 1). In particular, at least one reference fan parameter is stored in the storage unit 20a. Advantageously, a plurality of reference fan parameters are stored in the storage unit 20a. For example, the reference fan parameters could be stored in the storage unit 20a in the form of a table and/or in the form of a mathematical function. Only one of the reference fan parameters are described below.

In particular, the control unit 16a takes into consideration the reference fan parameter in the case of determining the filter parameter. In the case of determining the filter parameter, the control unit 16a compares in particular the detected fan parameter with the stored reference fan parameter. The control unit 16a determines the filter parameter in particular from a comparison of the detected fan parameter with the reference fan parameter.

In particular an extract of a test to determine the filter parameter is illustrated in the following table. In particular, test conditions and detected fan parameters are illustrated in the table.

| Theo. | | | Voltage | Current | Power | Expert |
|---|---|---|---|---|---|---|
| RPM | Filter | Door | [V] | [A] | [W] | RPM |
| 1625 | No | Closed | 23.819 | 0.338 | 9.100 | 1603 |
| 1625 | No | Open | 23.829 | 0.379 | 9.000 | 1603 |
| 1625 | Yes | Closed | 23.869 | 0.225 | 5.400 | 1603 |
| 1625 | Yes | Open | 23.871 | 0.225 | 5.300 | 1603 |
| 1625 | No | Closed | 23.840 | 0.316 | 7.500 | 1600 |
| 1625 | No | Open | 23.800 | 0.336 | 8.000 | 1600 |
| 1625 | Yes | Closed | 23.870 | 0.196 | 4.590 | 1600 |
| 1625 | Yes | Open | 23.871 | 0.200 | 4.750 | 1600 |

In particular, a theoretical value of a rotational speed is represented in a first column that is labelled “Theo. RPM”. In particular, a presence of the filter unit 18a is represented in a second column that is labelled “Filter”. In particular, an opening state of the appliance door 26a is represented in a third column that is labelled “Door”.

In particular, a detected value of an electrical voltage that is provided for operation of the drive motor 40a is represented in the unit volts in a fourth column that is labelled with “Voltage [V]”. In particular, a detected value of an electrical current that is provided for operation of the drive motor 40a is represented in the unit amps in a fifth column that is labelled “Current [A]”. In particular, a detected value of an electrical power that is provided for operation of the drive motor 40a is represented in the unit watts in a sixth column that is labelled “Power [W]”. In particular, a detected value of a rotational speed is represented in a seventh column that is labelled “Expert. RPM”.

It is in particular apparent from the table that the fan parameter that comprises an electrical current is dependent upon a presence of the filter unit 18a. In particular, a value of the fan parameter that comprises an electrical current is lower in the case of a presence of the filter unit 18a than in the case of an absence of the filter unit 18a. The filter parameter that the control unit 16a determines, in dependence upon the fan parameter, comprises in particular at least one presence parameter of the filter unit 18a.

As is apparent in particular from the table, the dependence of the fan parameter is in particular not dependent upon the presence of the filter unit 18a. It is apparent in particular from the table that for the determination of the filter parameter the control unit 16a maintains as at least essentially constant the further fan parameter that comprises at least one rotational speed. In particular for the determination of the filter parameter, the control unit 16a maintains as at least essentially constant the further fan parameter that comprises at least one electrical voltage.

In the case of determining the filter parameter, the control unit 16a in particular takes into consideration at least one opening state of the appliance door 26a. In particular, the opening state of the appliance door 26a influences a saturation value of the fan parameter.

In particular, in addition to the filter parameter that comprises at least one presence parameter of the filter unit 18a, the control unit 16a determines, in dependence upon the fan parameter, at least one filter parameter that comprises at least one soiling parameter of the filter unit 18a. The filter parameter that the control unit 16a determines, in dependence upon the fan parameter, comprises in particular at least one soiling parameter of the filter unit 18a.

In a method for operation of the cooking appliance apparatus 10a, at least one filter parameter of the filter unit 18a, which is allocated to the fan unit 12a, is determined in dependence upon the fan parameter. In particular, in a detection step 42a, the electrical fan parameter of the fan unit 12a is detected in particular by means of the sensor unit 14a (cf. FIG. 4).

In particular in a determining step 44a, the filter parameter of the filter unit 18a, which is allocated to the fan unit 12a, is determined in dependence upon the fan parameter. The reference fan parameter is taken into consideration in the case of determining the filter parameter, in particular in the determining step 44a. In particular, the further fan parameter is maintained as constant for the determination of the filter parameter, in particular in the detection step 42a and/or in the determining step 44a.

In particular in an action step 46a, in particular by way of the control unit 16a, in particular in dependence upon the determined filter parameter, at least one action is at least introduced and advantageously performed. The action could be for example an output of at least one item of information to an operator. In particular alternatively or in addition thereto, the action could be in particular an execution of a cooking program and/or a cooking process.

### LIST OF REFERENCE CHARACTERS

10 Cooking appliance apparatus
12 Fan unit
14 Sensor unit
16 Control unit
18 Filter unit
20 Storage unit
22 Cooking compartment
24 Muffle
26 Appliance door
28 Cooking appliance
30 Operator interface
32 Heating element
34 Air guiding unit
36 Fan wheel
38 Passage region
40 Drive motor
42 Detection step
44 Determining step
46 Action step
50 Cooking compartment wall
52 Base wall
54 Cover wall
56 Rear wall
58 Side wall
60 Side wall

1-12. (canceled)

13. A cooking appliance apparatus, comprising:
a fan unit;
a sensor unit designed to detect an electrical fan parameter of the fan unit;
a filter unit allocated to the fan unit; and
a control unit designed to determine a filter parameter of the filter unit in dependence upon the fan parameter.

14. The cooking appliance apparatus of claim 13, constructed in the form of an induction cooking appliance apparatus.

15. The cooking appliance apparatus of claim 13, wherein the control unit is designed to maintain at least one further fan parameter as essentially constant, when determining the filter parameter.

16. The cooking appliance apparatus of claim 13, wherein the control unit includes a storage unit designed to store a reference fan parameter, said control unit designed to take the reference fan parameter into consideration when determining the filter parameter.

17. The cooking appliance apparatus of claim 13, further comprising an air guiding unit, said filter unit being arranged in a reversible manner on the air guiding unit.

18. The cooking appliance apparatus of claim 13, wherein the filter unit includes a smoke filter.

19. The cooking appliance apparatus of claim 13, further comprising a muffle designed to delimit at least in part a cooking compartment, said filter unit being arranged within the cooking compartment in an assembled state of the filter unit.

20. The cooking appliance apparatus of claim 13, wherein the fan parameter comprises an electrical current.

21. The cooking appliance apparatus of claim 13, wherein the filter parameter comprises a presence parameter.

22. The cooking appliance apparatus of claim 13, wherein the filter parameter comprises a soiling parameter.

23. The cooking appliance apparatus of claim 13, further comprising an appliance door, said control unit designed to take into consideration an opening state of the appliance door when determining the filter parameter.

24. A cooking appliance, in particular an induction cooking appliance, said cooking appliance comprising a cooking appliance apparatus which includes a fan unit, a sensor unit designed to detect an electrical fan parameter of the fan unit, a filter unit allocated to the fan unit, and a control unit designed to determine a filter parameter of the filter unit in dependence upon the fan parameter.

25. The cooking appliance of claim 24, constructed in the form of an induction cooking appliance.

26. A method for operating a cooking appliance apparatus, comprising:
detecting with a sensor unit a fan parameter of a fan unit of the cooking appliance apparatus; and
determining in dependence upon the fan parameter a filter parameter of a filter unit which is allocated to the fan unit.

27. The method of claim 26, further comprising maintaining at least one further fan parameter as essentially constant, when determining the filter parameter.

28. The method of claim 26, further comprising:
storing a reference fan parameter; and
considering the reference fan parameter when determining the filter parameter.

29. The method of claim 26, wherein the fan parameter is a parameter selected from the group consisting of an electrical current, a presence parameter, and a soiling parameter.

30. The method of claim 26, further comprising considering an opening state of an appliance door when determining the filter parameter.
